(19) United States
(12) Patent Application Publication
(10) Pub. No.: US 2026/0316859 A1
(43) Pub. Date: Oct. 15, 2026

(54) UNEVEN-EDGED TRACK FOR TRACTION OF A VEHICLE

(71) Applicant: CAMSO INC., Magog (CA)

(72) Inventors: Jean-Luke Noel, Magog (CA); Paul Vanasse, Magog (CA); Sylvain Cloutier, Magog (CA)

(73) Assignee: CAMSO INC., Magog (CA)

(21) Appl. No.: 19/113,664

(22) PCT Filed: Oct. 11, 2023
(86) PCT No.: PCT/CA2023/051344

§ 371 Date: Mar. 20, 2025

Related U.S. Application Data
(60) Provisional application No. 63/379,203, filed on Oct. 12, 2022.

(51) Int. Cl. B62D 55/26; B62D 55/24

(52) U.S. Cl. CPC B62D 55/26; B62D 55/24

(57) ABSTRACT

The present disclosure concerns a track for traction of a vehicle, the track being mountable around a track-engaging assembly of the vehicle, the track-engaging assembly comprising a plurality of wheels, the track having a longitudinal direction and comprising a carcass comprising an outer ground-engaging side, an opposed inner wheel-facing side, and first and second lateral edges extending along the longitudinal direction between the outer and inner sides, the first and second lateral edges being spaced apart from each other in a width direction of the track; ground-receiving recesses are formed on at least one of the first and second lateral edges.

### PRIOR APPLICATION

The present application claims priority from U.S. provisional patent application No. 63/379,203, filed on Oct. 12, 2022, and entitled “UNEVEN-EDGED TRACK FOR TRACTION OF A VEHICLE”, the disclosure of which being hereby incorporated by reference in its entirety.

### TECHNICAL FIELD

The technical field relates to vehicles and, more particularly, to vehicles comprising track systems for traction.

### BACKGROUND

Certain vehicles, including industrial vehicles, military vehicles (e.g., armored personnel carriers, infantry fighting vehicles, etc.), agricultural vehicles (e.g., harvesters, combines, tractors, etc.), construction vehicles (e.g., mini-excavators, small loaders, etc.), and forestry vehicles (e.g., feller-bunchers, tree chippers, knuckleboom loaders, etc.), snowmobiles, and all-terrain vehicles (ATVs), for example, may be equipped with track systems to enhance their traction, floatation on soft, slippery and/or irregular grounds (e.g., mud, sand, snow, etc.) on which they operate. Track systems comprise a track and a track-engaging assembly (e.g., comprising wheels) for driving and guiding their track around their track-engaging assembly to distribute the weight of the vehicle on the ground.

However, the improved traction provided by the use of tracks may remain insufficient to ensure an acceptable mobility in some particularly soft terrains. Historically, traction capabilities of rubber tracks were improved by increasing a height, changing a geometry and/or changing a spacing of ground-engaging traction profiles configured to be in direct and constant contact with the ground. Despite these improvements, current tracks on the market do not offer sufficient increased traction in such very soft terrain applications. There is also a loss of traction experienced by tracked vehicles in sidehill applications where dynamics of the vehicle do not allow a proper contact between the ground and the track. Current rubber tracks on the market do not offer adequate traction in sidehill applications. Such specific lacks of traction situations have not really been addressed by the industry yet. Another common problem of the existing tracks is a relative high rolling resistance, i.e., an energy consumption required to move the track around the track-engaging assembly. There has been a continuous improvement process towards a reduction of rolling resistance in tracks, over the years, mainly by reducing a thickness of a track carcass or belt of the track. However, reducing the thickness of the carcass detrimentally reduces a durability of the track.

In view of the above, there is a need for a track which would be able to overcome or at least minimize some of the above-discussed prior art concerns.

### BRIEF SUMMARY

It is therefore an aim of the present invention to at least partially address the above-mentioned issues.

According to a general aspect, there is provided a track for traction of a vehicle, the track being mountable around a track-engaging assembly of the vehicle, the track-engaging assembly comprising a plurality of wheels, the track having a longitudinal direction and comprising: a carcass comprising an outer ground-engaging side, an opposed inner wheel-facing side, and first and second lateral edges extending along the longitudinal direction between the outer and inner sides, the first and second lateral edges being spaced apart from each other in a width direction of the track; wherein ground-receiving recesses are formed on at least one of the first and second lateral edges.

According to another general aspect, there is provided a track for traction of a vehicle, the track being mountable around a track-engaging assembly of the vehicle, the track-engaging assembly comprising a plurality of wheels, the track having a longitudinal direction and comprising: a carcass comprising an outer ground-engaging side and an opposed inner wheel-facing side, first and second lateral edges extending between the outer and inner sides, the first and second lateral edges being spaced apart from each other in a width direction of the track; and wherein at least one of the first and second lateral edges comprises ground-engaging protrusions.

According to another general aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground, an inner surface opposite to the ground-engaging outer surface, a first lateral edge extending from the ground-engaging outer surface to the inner surface, and a second lateral edge extending from the ground-engaging outer surface to the inner surface and opposite to the first lateral edge of the track; and a plurality of traction projections projecting from the ground-engaging outer surface. The first lateral edge is uneven in a longitudinal direction of the track.

According to another broad aspect, there is provided a vehicle track mountable around a track-engaging assembly of a vehicle, the vehicle track comprising: a carcass comprising a ground-engaging outer surface for engaging a ground upon rotation about the track-engaging assembly, an opposed inner surface, and first and second lateral edges extending between the outer and inner surfaces, the first and second lateral edges being spaced apart from each other in a width direction of the track; wherein at least one of the first and second lateral edges comprises a plurality of ground-engaging formations spaced apart from one another along a longitudinal direction of the vehicle track.

In some specific implementations, the second lateral edge is uneven in the longitudinal direction of the track. An unevenness of the second lateral edge in the longitudinal direction of the track may be configured to generate traction when the second lateral edge engages the ground.

According to another broad aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground, an inner surface opposite to the ground-engaging outer surface, and lateral edges opposite one another and extending from the ground-engaging outer surface to the inner surface; and a plurality of traction projections projecting from the ground-engaging outer surface. Each lateral edge comprises a plurality of formations that are spaced from one another in a longitudinal direction of the track.

According to another broad aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground, an inner surface opposite to the ground-engaging outer surface, and lateral edges opposite one another and extending from the ground-engaging outer surface to the inner surface; and a plurality of traction projections projecting from the ground-engaging outer surface. Each lateral edge comprises a plurality of recesses that are spaced from one another in a longitudinal direction of the track.

According to another broad aspect, there is provided a track for traction of a vehicle. The track is mountable around a track-engaging assembly comprising a plurality of wheels, the wheels including a drive wheel configured to drive the track around the track-engaging assembly. The track is elastomeric to flex around the track-engaging assembly. The track comprises: a carcass comprising a ground-engaging outer surface for engaging a ground, an inner surface opposite to the ground-engaging outer surface, and lateral edges opposite one another and extending from the ground-engaging outer surface to the inner surface; a plurality of traction projections projecting from the ground-engaging outer surface; and a plurality of drive projections projecting from the inner surface and configured to engage the drive wheel. Each lateral edge is uneven in a longitudinal direction of the track.

According to another broad aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground, an inner surface opposite to the ground-engaging outer surface, and lateral edges opposite one another and extending from the ground-engaging outer surface to the inner surface; and a plurality of traction projections projecting from the ground-engaging outer surface. Each lateral edge comprises a plurality of tractive formations that are spaced from one another in a longitudinal direction of the track and spaced from the traction projections.

According to another broad aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground, an inner surface opposite to the ground-engaging outer surface, and lateral edges opposite one another and extending from the ground-engaging outer surface to the inner surface; and a plurality of traction projections projecting from the ground-engaging outer surface. The track is free of stiffening bars embedded in the carcass, extending transversally to a longitudinal direction of the track, and spaced from one another in the longitudinal direction of the track. Each lateral edge comprises a plurality of recesses that are spaced from one another in the longitudinal direction of the track and extend to at least one of the ground-engaging outer surface and the inner surface.

According to another broad aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground, an inner surface opposite to the ground-engaging outer surface, and lateral edges opposite one another and extending from the ground-engaging outer surface to the inner surface; and a plurality of traction projections projecting from the ground-engaging outer surface. Each lateral edge comprises a plurality of recesses that are spaced from one another in a longitudinal direction of the track and collectively occupy a majority of a length of the track.

### BRIEF DESCRIPTION OF THE DRAWINGS

FIG. 1 shows an example of a vehicle comprising a plurality of track systems, each track system comprising a track-engaging assembly with a track according to an embodiment of the disclosure mounted thereto;

FIG. 2 shows a perspective view of one of the track systems of FIG. 1;

FIG. 3 shows a perspective view of the track of FIG. 2;

FIGS. 4 to 8 show respectively an outer perspective view, an outer elevation view, an inner elevation view, a cross sectional view in a width direction thereof, and a side elevation view of a portion of the track of FIG. 3;

FIG. 9 shows a partial front view of a track system in accordance with an embodiment in relationship with a soft ground;

FIG. 10 shows a partial front view of a track system in accordance with an embodiment in relationship with a soil comprising a sidehill;

FIGS. 11 to 15 show different possible embodiments of a cross-section of ground-receiving recess of a track in accordance with the present disclosure, considered in a thickness direction of the track;

FIGS. 16 to 20 show an outer perspective view of a portion of different possible embodiments of the track in accordance with the present disclosure;

FIGS. 21 to 23 show cross-sectional views of embodiments of the track in accordance with the present, the tack comprising a layer of reinforcing fabric, considered in longitudinal and width directions of the track; and

FIG. 24 is an outer perspective view of a portion of the track of FIG. 23.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the track system and its components and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

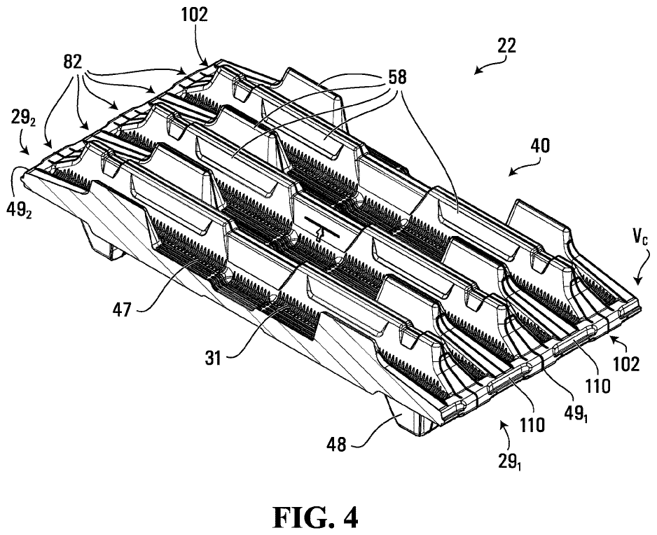

Referring now to the drawings, and more particularly to FIG. 4, there is shown a track for traction of a vehicle. The track is mountable to a track-engaging assembly of the vehicle. As detailed below, the track comprises a carcass comprising an outer ground-engaging side for engaging a ground, an opposed inner wheel-facing side, first and second lateral edges extending between the outer and inner sides, the first and second lateral edges being spaced apart from each other in a width direction of the track. As detailed below, at least the first lateral edge is uneven considered in a longitudinal direction of the track. It is understood that the width direction is transversal, for instance perpendicular, to the longitudinal direction of the track. In other words, and as detailed below, ground-receiving recesses are formed on at least one of the first and second lateral edges and/or at least one of the first and second lateral edges comprises ground-engaging protrusions.

### Vehicle

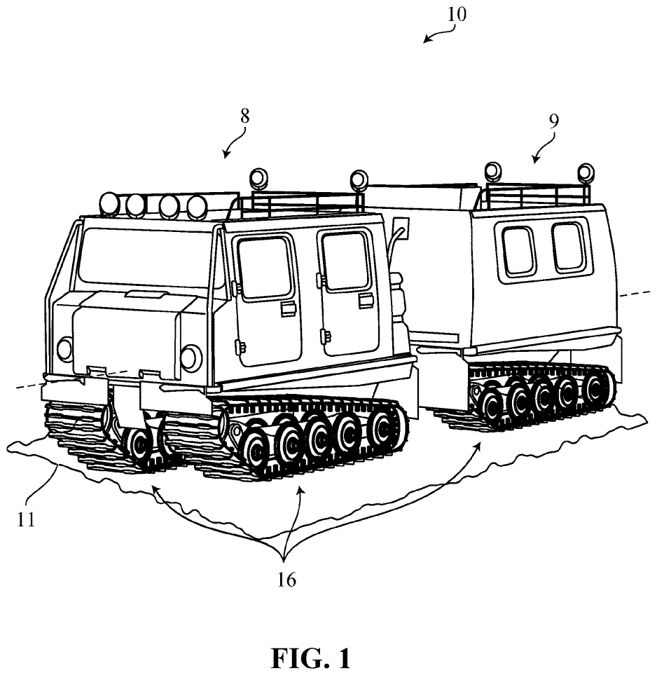

For instance and without being limitative, as represented in FIG. 1, the vehicle 10 might be a military articulated vehicle (e.g., an armored personnel carrier). The vehicle 10 comprises a plurality of track systems 16 including tracks 22 for traction (four, in the embodiment shown). In the embodiment shown, each of front and rear units 8, 9 of the vehicle 10 comprises at least one pair of the track systems 16. In other examples, the military vehicle 10 may be any other type of military vehicle (e.g., a military vehicle including a single cabin, being not articulated, etc.). In some cases, the ground 11 supporting the vehicle 10 may be a soft terrain (e.g., snow, mud and/or sludge) and/or may comprise a sidehill. The vehicle 10 can also be “roading”, i.e., travelling on a road (i.e., a paved road having a hard surface of asphalt, concrete, gravel, or other pavement), such as between off-road operations.

Although the vehicle 10 illustrated in FIG. 1 is an articulated military vehicle comprising two units, different types of military vehicles configured differently (e.g., having a different number of units, being non-articulated, having a different number of track systems, etc.) may implement improvements based on principles disclosed herein. For instance and without being limitative, the vehicle 10 may be an agricultural vehicle (e.g., a tractor, combine harvester, another type of harvester, grain carts, sprayer, or any other type of agricultural vehicle, autonomous or manned) for performing agricultural work on an agricultural field (e.g., soil), an industrial vehicle such as a construction vehicle (e.g., a loader, a telehandler, a bulldozer, an excavator, etc.) for performing construction work or a forestry vehicle (e.g., a feller-buncher, a tree chipper, a knuckle boom loader, etc.) for performing forestry work, an all-terrain vehicle (ATV), a snowmobile, or any other vehicle operable off paved roads. Although operable off paved roads, the vehicle 10 may also be operable on paved roads in some cases.

### Track

### General Features

As further discussed, the tracks 22 of the vehicle 10 are configured to increase a number and/or an extent of surfaces of the track 22 that engage a ground when the vehicle 10 is travelling on a soft terrain and/or on a sidehill, while reducing a rolling resistance of the track 22, such as, notably, to enhance traction, to reduce a total weight of the vehicle 10, to reduce an energy consumption of the vehicle 10, and/or to increase an effective power of the vehicle 10.

The track 22 engages the ground to provide traction to the vehicle 10. A length of the track 22 allows the track 22 to be mounted around a track-engaging assembly 21 of the vehicle 10 and to form therewith one of the track systems 16. In view of its closed configuration without ends that allows it to be disposed and moved around the track-engaging assembly 21 (i.e., the track forms substantially a loop around the track-engaging assembly), the track 22 can be referred to as an “endless” track.

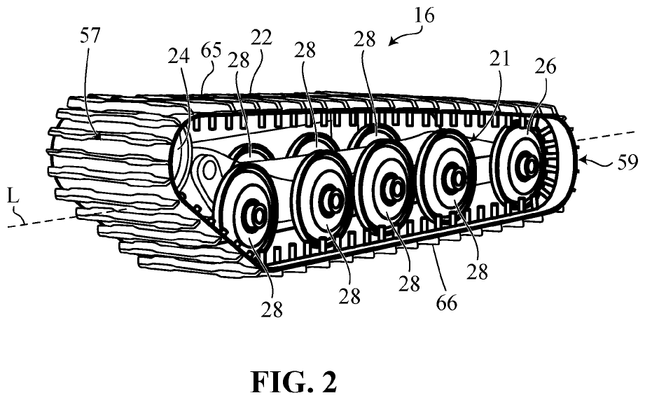

With additional reference to FIGS. 2 to 8, the track 22 (for instance a carcass thereof) comprises an inner wheel-engaging side 45, an opposed ground-engaging outer side 47, and lateral edges 49₁, 49₂ extending along the longitudinal direction of the track and spaced apart from each other in the width direction of the track; the lateral edges extend between the inner and outer sides and connect the inner and outer sides to each other. The lateral edges 49₁, 49₂ comprise a first lateral edge 49₁ on (or at least partially forming) a first lateral side 29₁ of the track 22 and a second lateral edge 49₂ on (or at least partially forming) a second lateral side 29₂ of the track 22. The inner side 45 (or wheel-facing side or wheel-engaging face) faces the wheels 24, 26, 28 of the track-engaging assembly, while the ground-engaging outer side 47 is configured to engage the ground upon rotation of the track around the track-engaging assembly. A top run 65 of the track 22 extends between longitudinal ends 57, 59 (respectively front and rear ends) of the track system 16 and over the wheels 24, 26, 28, while a bottom run 66 of the track 22 extends between the longitudinal ends 57, 59 of the track system 16 and under the wheels 24, 26, 28. The bottom run 66 of the track 22 defines an area of contact of the track 22 with the ground which generates traction and bears a majority of a load on the track system 16, and which will be referred to as a “contact patch” of the track 22 with the ground. The track 22 has a longitudinal axis L which defines the longitudinal direction of the track 22 (i.e., a direction generally parallel to its longitudinal axis) and transversal directions of the track 22 (i.e., directions transverse to its longitudinal axis), including a widthwise direction of the track 22 (i.e., a lateral direction generally perpendicular to its longitudinal axis). The track 22 has a thickness direction normal to its longitudinal and widthwise directions.

In the embodiment shown, the track 22 is relatively wide to efficiently distribute a load of the vehicle 10 over the ground 11, to enhance floatation and to increase traction of the track 22. For instance, in some embodiments, the width W of the track 22 may be at least 4 inches, in some embodiments at least 6 inches, in some embodiments at least 12 inches, in some embodiments at least 24 inches, in some embodiments at least 36 inches, in some embodiments at least 48 inches.

The track 22 is at least partially elastomeric, i.e., comprises elastomeric material, to be flexible around the track-engaging assembly 21. The elastomeric material of the track 22 can include any polymeric material with suitable elasticity. In this embodiment, the elastomeric material of the track 22 includes rubber. Various rubber compounds may be used and, in some cases, different rubber compounds may be present in different areas of the track 22. In other embodiments, the elastomeric material of the track 22 may include another elastomer in addition to or instead of rubber (e.g., polyurethane elastomer).

More particularly, the track 22 comprises an endless body 36 (or carcass) underlying its inner side 45 and its ground-engaging outer side 47. In view of its underlying nature, the body 36 will be referred to as a “carcass”. The carcass 36 is at least partially elastomeric in that the carcass 36 comprises elastomeric material 38 which allows the carcass 36 to elastically change in shape and thus allows the track 22 to flex as it is in motion around the track-engaging assembly 21.

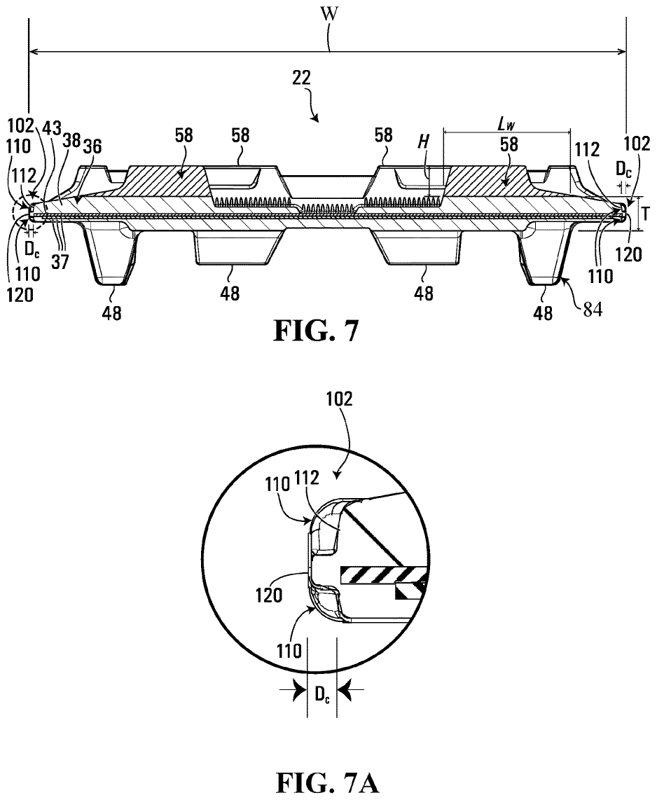

The carcass 36 might comprise a plurality of reinforcements. Specifically, in this embodiment, the carcass 36 might comprise a plurality of reinforcements embedded in its elastomeric material 38 and spaced from one another. These reinforcements can take on various forms, such as reinforcing layers. The carcass 36 might comprise a layer of reinforcing cables 37 (FIG. 7) that are adjacent to one another and extend generally in the longitudinal direction of the track 22 to enhance strength in tension of the track 22 along its longitudinal direction.

As another example, and as detailed below, the carcass 36 might comprise a layer of reinforcing fabric 43. The carcass 36 may be molded into shape in a molding process during which the rubber 38 is cured. For example, in this embodiment, a mold may be used to consolidate layers of rubber providing the rubber 38 of the carcass 36, the reinforcing cables 37 and/or the layer of reinforcing fabric 43.

The inner side 45 of the endless track 22 comprises an inner surface 32 of the carcass 36 and a plurality of wheel-contacting projections 48 (or wheel-engaging projections) that project (or protrude) from the inner surface 32 and are shaped and dimensioned to contact at least some of the wheels 24, 26, 28 to do at least one of driving (i.e., imparting motion to) the track 22 and guiding the track 22.

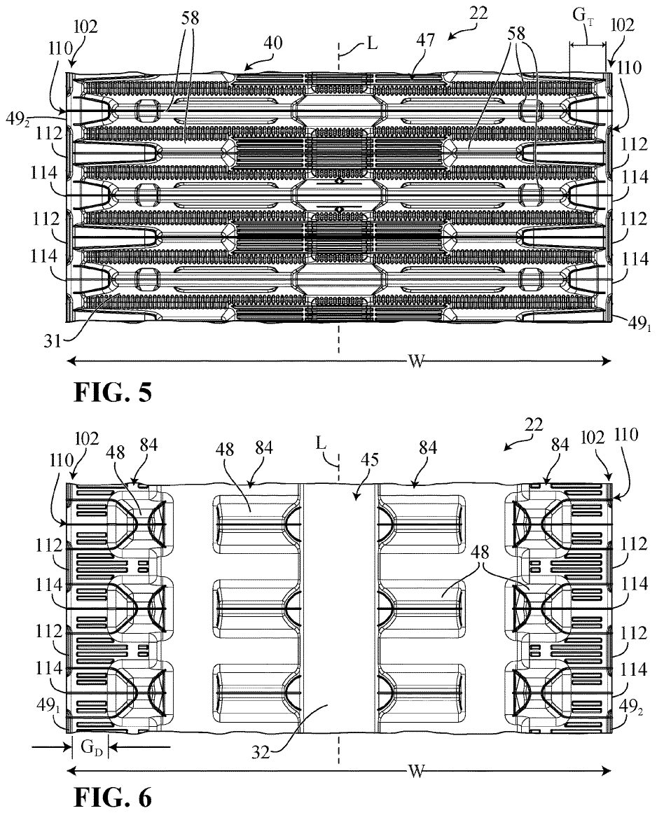

As best shown in FIG. 6, in the embodiment shown, a shape of the periphery of the drive/guide lugs 48 and/or dimensions thereof might differ from each other. For instance, a shape of the periphery of the inner ones (considered with regard to a central axis of the track) of rows 84 of guide lugs 48 may be different from a shape of the periphery of the drive/guide lugs 48 of the outer ones of the rows 84. In particular, in this embodiment, as best shown in FIGS. 7 and 8, a dimension considered in the thicknesswise direction of the drive/guide lugs 48 of the inner ones of one of the rows 84 may be smaller than a corresponding dimension considered in the thicknesswise direction of the drive/guide lugs 48 of the outer ones of one of the rows 84, and a dimension of the drive/guide lugs 48 considered in the widthwise direction of the track 22 of the inner ones of one of the rows 84 may be greater than a corresponding dimension considered in the widthwise direction of the drive/guide lugs 48 of the outer ones of one of the rows 84.

### Outer Side

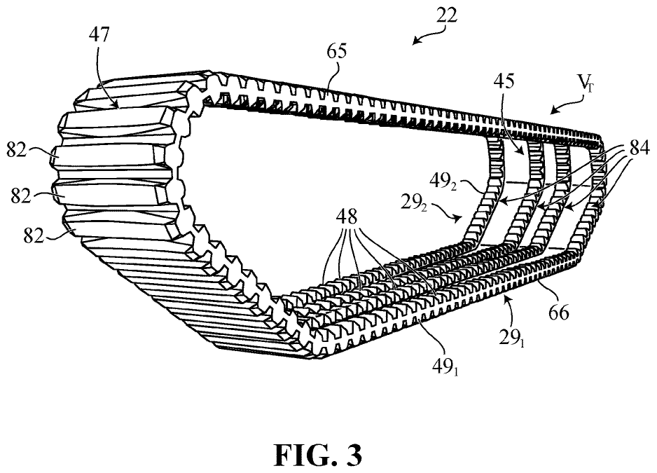

With additional reference to FIGS. 3 to 8, in this embodiment, the track 22 comprises a traction system configured to enhance traction of the track 22 on the ground. In particular, in this embodiment, the traction system may be implemented by a plurality of ground-engaging surfaces configured to provide traction on the ground.

For instance, in this embodiment and as best shown in FIGS. 4 and 5, the ground-engaging outer side 47 of the track 22 comprises a ground-engaging outer surface 31 of the carcass 36 and a tread pattern 40 formed on the ground-engaging outer surface to enhance traction on the ground. The tread pattern 40 comprises a plurality of traction projections 58 (or ground-engaging projections 58) projecting from (or protruding from) the ground-engaging outer surface 31, spaced apart in the longitudinal direction of the endless track 22 and engaging the ground to enhance traction. The traction projections 58 may be referred to as “traction profiles”, “tread projections” or “traction lugs”. The traction projections 58 may be arranged in traction projection rows 82 each extending in the widthwise direction of the track 22 and disposed along the length of the track 22. Consecutive ones of the traction projection rows 82 may be spaced by a spacing S in the longitudinal direction of the track 22 (FIG. 8).

As best shown for instance in FIGS. 7 and 8, each traction lug 58 has a front-to-rear dimension L_{L} in the longitudinal direction of the endless track 22 and a side-to-side dimension L_{W} in the widthwise direction of the endless track 22. In some cases, the front-to-rear dimension LL may be a width of the traction lug 58 while the side-to-side dimension L_{W} may be a length of the traction lug 58. In other cases, the front-to-rear dimension L_{L} may be a length of the traction lug 58 while the side-to-side dimension L_{W} may be a width of the traction lug 58. In yet other cases, the front-to-rear dimension L_{L} and the side-to-side dimension Lw may be substantially the same (i.e., the traction lug might have a substantially square cross-section). The traction lug 58 also has a height H (considered in a direction corresponding to the thickness of the track).

The traction lugs 58 may have any suitable shape. For instance, the traction lug 58 might have an elongated shape and be angled, i.e., might define an oblique angle (i.e., an angle that is not a right angle or a multiple of a right angle), relative to the longitudinal direction of the track 22. The traction lugs 58 may have various other shapes in other examples (e.g., curved shapes, shapes with straight parts and curved parts, etc.).

### Lateral Edges of the Track

In this embodiment, the carcass 36 comprises lateral edges 102 extending from the inner surface 32 of the carcass 36 to the ground-engaging outer surface 31 of the carcass 36 (i.e., between the inner and outer surfaces of the carcass) on each side of the carcass 36 considered along a width thereof. The lateral edges 102 may comprise a first lateral edge and a second lateral edge opposite to the first lateral edge. The first lateral edge 491 of the track 22 faces and is at least partially formed by the first lateral edge of the carcass 36 and the second lateral edge 682 of the track 22 faces and is at least partially formed by the second lateral edge of the carcass 36. In particular, in this embodiment, the lateral edges 102 of the carcass 36 define the first and second lateral edges 49₁, 49₂ of the track 22.

In some specific applications, at least part of each of the ground-engaging outer surface 31 of the carcass (at least partially forming the outer side 47 of the track 22) and a single one of the lateral edges 102 of the carcass are configured to engage the ground simultaneously when the vehicle 10 is travelling on the field 11. In some specific applications, at least part of each of the ground-engaging outer surface 31 and both lateral edges 102 are configured to engage the ground simultaneously when the vehicle 10 is travelling on the field 11.

### First Embodiment (FIGS. 4 to 8)

As mentioned above, in the track 22 according the present disclosure, at least one of the first and second lateral edges 102 of the carcass (forming at least partially the first and second lateral edges of the track 22) comprises an unevenness in the longitudinal direction of the track 22 forming at least partially the above-mentioned traction system, and the unevenness is configured (i.e., shaped and dimensioned) to generate traction when the lateral edge engages the ground. In particular, the lateral edge 102 may comprise a plurality of formations 110 that are spaced from one another in the longitudinal direction of the track and make the lateral edge 102 uneven in the longitudinal direction of the track 22. More specifically, in this embodiment, the formations 110 are tractive formations (or ground-engaging formations, or traction-providing formations) configured (i.e., shaped and dimensioned) to generate traction when the lateral edge 102 engages the ground.

In this embodiment, each lateral edge 102 (i.e., the first and second lateral edges 49₁, 49₂) is uneven (i.e., non-flat/non-straight) considered along the longitudinal direction of the track 22. That is, the lateral edge 102 deviates from a straight line or substantially straight surface that would be substantially parallel to the longitudinal direction of the track 22, such as by comprising one or more curved parts and/or one or more angular parts therealong.

It could also be conceived a track wherein a single one of the lateral edges of the carcass would be uneven, and the other lateral edge of the carcass 36 the track would be even.

The tractive formations 110 may extend to at least one of the ground-engaging outer surface 31 and the inner surface 32 of the carcass 36 (i.e., to at least one of the inner and outer sides 45, 47 of the track 22). More specifically, in this embodiment, the tractive formations 110 may extend to each of the ground-engaging outer surface 31 and the inner surface 32 of the carcass 36.

In the embodiment shown, the tractive formations 110 may not project from the inner surface 32 of the carcass 36. The tractive formations 110 may be spaced from the guide/drive lugs 48 of the track, considered in the width direction of the track. Thus, the tractive formations 110 may be independent from the guide/drive lugs 48, i.e., they might not be an extension or other continuity of the guide/drive lugs 48, as there is a gap G_{D} (see for instance FIG. 6) considered in the width direction of the track between the tractive formations 110 and the guide/drive lugs 48. For instance, the tractive formations 110 may be spaced from the guide/drive lugs 48 in the width direction of the track 22. The inner surface 32 may be horizontal between the tractive formations 110 and the guide/drive lugs 48 in the width direction of the track 22.

In this embodiment, the tractive formations 110 may not project from the ground-engaging outer surface 31 of the carcass 36. The tractive formations 110 may be spaced from the profiles 58 of the track considered in the width direction of the track. Thus, the tractive formations 110 may be independent from the profiles 58, i.e., they are not an extension or other continuity of the profiles 58, as there is a gap G_{T} (see for instance FIG. 5) considered in the width direction of the track 22 between them and the profiles 58. For instance, the tractive formations 110 may be spaced from the profiles 58 in the width direction of the track 22. The ground-engaging outer surface 31 may be horizontal between the tractive formations 110 and the profiles 58 in the width direction of the track 22.

### Lateral Recesses

More specifically, in this embodiment, the tractive formations 110 include (or at least partially delimit) lateral recesses 112 (or ground-receiving recesses) formed in the corresponding lateral edge. The recesses 112 may be configured to contain ground matter when the corresponding lateral edge 102 engages the ground. Conversely, in this embodiment, the tractive formations 110 can be viewed as including projections 114 (or ground-engaging protrusions), which can be viewed as defining (or at least partially delimiting) the lateral recesses 112 between adjacent ones of the projections 114.

In this embodiment, respective ones of the recesses 112 of the first lateral edge 102 may be aligned with (i.e., substantially in register with) respective ones of the recesses 112 of the second lateral edge 102 in the longitudinal direction of the track 22. Respective ones of the recesses 112 may be disposed between longitudinally-adjacent ones of the traction lugs 58 in the longitudinal direction of the track 22. Respective ones of the recesses might be substantially in register with respective ones of the traction lugs 58. Respective ones of the recesses 112 may be located between longitudinally-adjacent ones of the drive/guide lugs 48 in the longitudinal direction of the track 22.

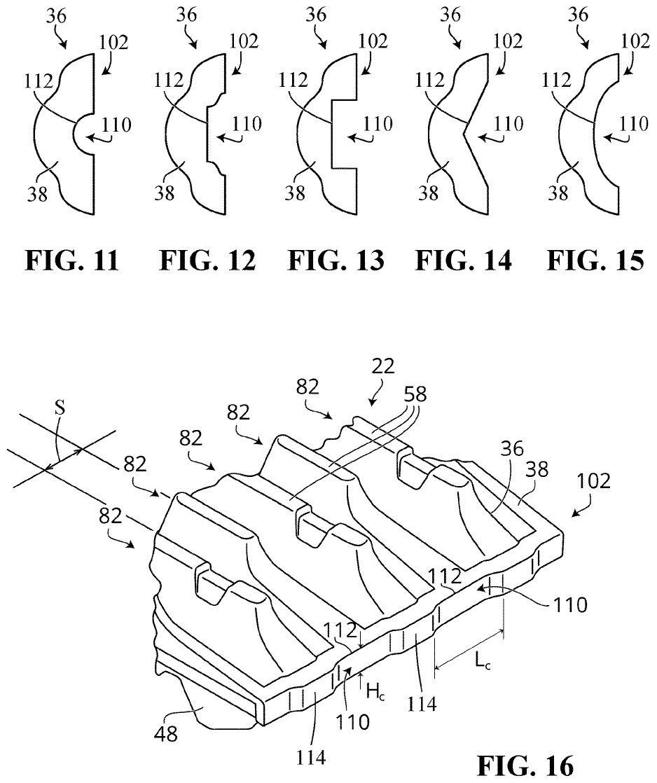

As best shown in FIGS. 11 to 15, the recesses 112 (or ground-engaging recesses) may have any suitable shape. In particular, the recesses 112 may be curved or angled when viewed in the thickness direction of the track 22. Additionally, in some embodiments, the recesses 112 may be configured to avoid or limit stress concentration, thus increasing durability and reducing occurrences of crack initiation. For instance, in this embodiment, each recess 112 may have a substantially trapezoidal shape (FIG. 12) when viewed in the thickness direction of the track 22. When viewed in the thickness direction, the recess might form a concavity (FIGS. 11 and 15) and may have an opening dimension, considered in the thickness direction, representing less than about 25% of the thickness of the track (FIG. 11), or up to 75% of the thickness of the track (FIG. 15). The recess 112 might also have a substantially angled cross-section, for instance forming a substantially triangular cross-section (FIG. 14), or a substantially rectangular cross-section (FIG. 13).

The recesses 112 may have any suitable depth (considered in the widthwise direction of the track). For instance, in some embodiments, each recess 112 may have a dimension D_{C} (see for instance FIG. 7) in the width direction of the track 22 that may be at least 0.5 cm, in some embodiments at least 1 cm, in some embodiments at least 1.5 cm, in some embodiments at least 2 cm, and in some embodiments even more (e.g., at least 2.5 cm). In some embodiments, a ratio of the dimension Dc of the recess 112 in the width direction of the track 22 over the width W of the track 22 may be at least 1%, in some embodiments at least 10%, in some embodiments at least 20%, or in some embodiments at least 25%. In some embodiments, also, the dimension D_{C} of the recesses 112 may vary, i.e., respective dimensions D_{C} of different ones of the recesses 112 may be different from one another.

The recesses 112 may have any suitable length, considered along the longitudinal direction of the track 22. For instance, in some embodiments, each recess 112 may have a dimension L_{C} (see for instance FIG. 8) in the longitudinal direction of the track 22 and a ratio of the dimension L_{C} of the recess 112 in the longitudinal direction of the track 22 over the spacing S of the traction rows 82 of the track 22 (i.e., over a distance considered along the longitudinal direction of the track 22 between two consecutive rows of the traction projections 58) may be at least 0.1, in some embodiments at least 0.3, in some embodiments at least 0.5, and in some embodiments even more (e.g., at least 0.8). In some embodiments, also, the dimension L_{C} of the recesses 112 may vary, i.e., respective dimensions Lc of different ones of the recesses 112 may be different from one another.

The recesses 112 may have any suitable height, considered in the thickness direction of the track 22. For instance, in some embodiments, a ratio of a dimension H_{C} (see for instance FIG. 8) of the recess 112 in the thickness direction of the track 22 over the thickness T of the carcass 36 may be at least 0.8, in some embodiments at least 0.9, and in some embodiments about 1.

For instance, in this embodiment, each lateral edge 102 may comprise a plurality of protrusions 120 (or ground-engaging protrusions) aligned with (i.e., substantially in register with) corresponding ones of the ground-receiving recesses 112 in the longitudinal direction of the track 22. In particular, in this embodiment, each of the protrusions 120 may be elongate and may protrude relative to the recesses to a lateral point defining the width W the track 22. Specifically, in this embodiment, each protrusion 120 may split the corresponding recess 112 in two elongate parts spaced from one another by the protrusion 120 in the thickness direction of the track 22. In yet other words, a lateral protrusion might protrude from an inner surface at least partially delimiting one of the lateral recesses 112.

More specifically, in this embodiment, each protrusion 120 may include a ridge 128 (see for instance FIG. 8) extending in the longitudinal direction of the track 22, and the ridge 128 may define an extremity (i.e., a local apex) of the carcass 36 in the width direction of the track 22. The protrusion 120 may have any suitable thickness. In other words, the ground-engaging ridge 128 protrudes from an inner surface at least partially delimiting one of the ground-receiving recesses. In yet other words, the ground-engaging protrusion or ground-engaging ridge 128 is at least partially surrounded by a ground-receiving recess 112 formed in the corresponding one of the first and second lateral edges, the ground-engaging protrusion or ridge defining a local apex of the carcass considered in the width direction of the track 22.

In this embodiment, the recesses 112 of each lateral edge 102 collectively occupy a majority of the length of the track 22. That is, a sum of the dimension L_{C} of each recess 102 in the longitudinal direction of track 22 may be greater than about 50% of the length of track 22. For instance, in some embodiments, the recesses 112 of the lateral edge 102 collectively occupy at least 60% of the length of the track 22, in some embodiments at least 70% of the length of the track 22, and in some embodiments even more (e.g., at least 75% of the length of the track 22).

The recesses 112 may define a volume V_{C} that is substantial relative to a volume V_{T} of the track 22 and may contribute to substantially reduce a weight of the track 22 and/or a rolling resistance of the track 22. The total volume V_{C} may be obtained by calculating a product of the dimension D_{C} of the recesses 112, of the dimension L_{C} of the recesses 112, of the dimension H_{C} of the recesses 112, and of the number of recesses 112 of the track 22. For instance, in some embodiments, a ratio of the total volume V_{C} of the recesses 112 of the track 22 over the volume V_{T} of the track 22 may be at least about 1%, in some embodiments at least 5%, and in some embodiments at least 10%. In some embodiment, a ratio of the total volume V_{C} of the recesses 112 of the track 22 over a volume defined by a product of the length of the track 22, the width W of the track 22, and the thickness T from the ground-engaging outer surface 31 to the inner surface 32 of the track 22 may be at least about 1%, in some embodiments at least 5%, and in some embodiments at least 10%. This may result in the track 22 having a linear mass density that is less than 35 kg/m, in some embodiments less than 30 kg/m, and in some embodiments less than 25 kg/m.

In some embodiments, the lateral ground-receiving recesses 112 reduce the rolling resistance of the track 22 by at least about 2%, in some embodiments by at least 5%, in some embodiments by at least 7%, in some embodiments by at least 8%, and in some embodiments by at least 12%.

The weight reduction provided by the lateral ground-receiving recesses 112 formed in the first and second lateral edges may be estimated by computing a phantom mass which represents a mass of the elastomeric material 38 of the carcass 36 occupying the total volume V_{C} of the recesses 112. The phantom mass may thus be defined by the product of the total volume V_{C} of the recesses 112 and a density of the elastomeric material 38 of the carcass 36. In some embodiments, a ratio of the phantom mass of the track 22 over the weight of the track 22 may be at least about 5%, in some embodiments at least 10%, and in some embodiments at least 15%, and in some embodiments even more.

The recesses 112 may also increase cooling capabilities of the track 22. For instance, the recesses 112 may increase a surface area of the track 22 that is exposed to an environment of the vehicle 10 and may increase a heat transfer between the track 22 and its environment. Such track cooling effect may diminish probabilities of occurrence of overheat of the carcass 36 and may thus increase a life of the track 22.

The lateral edges 102 of the carcass 36, including the tractive (or ground-engaging) formations 110, including the recesses 112 and/or the projections 114, may be manufactured in any suitable fashion. For instance, in some embodiments, the recesses 112 may be formed by machining/punching out the carcass 36 after the molding of the carcass 36. In some embodiments, the recesses 112 and/or the projections 114 may be formed during the molding of the carcass 36. In some embodiments, the projections 114 may be formed by adding material to the carcass 36 after molding of the carcass 36. For instance, this may be achieved by additive manufacturing, e.g., 3D printing.

### Possible Variants of the Shape of the Recesses (FIGS. 16 to 20)

As best shown in FIG. 16, the lateral ground-receiving recesses 110 might be dimensioned so as to have a length L_{c}, considered along the longitudinal direction of the track 22, being greater than a longitudinal space S delimited by two longitudinally consecutive traction projection rows 82.

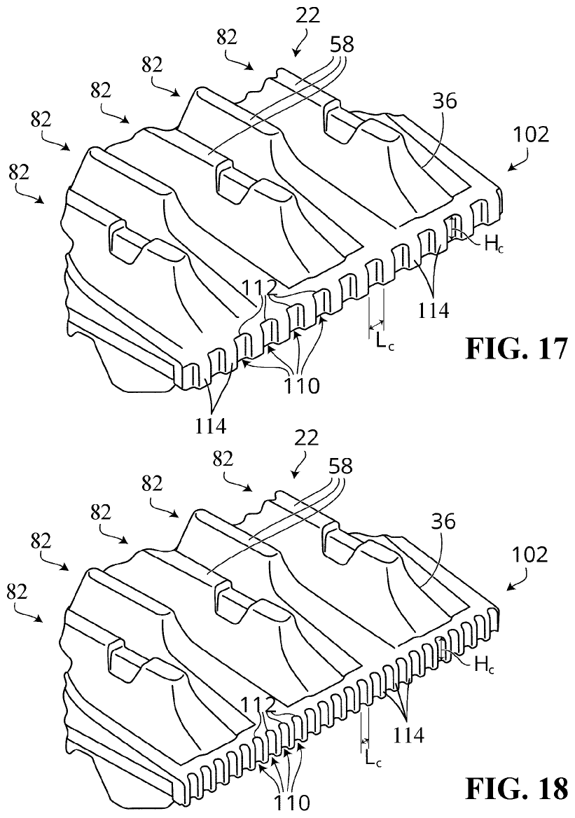

As another example, as shown in FIGS. 17 and 18, in some embodiments, each lateral edge 102 may comprise more than one recess 112 between consecutive ones of the traction projection rows 82, considered along the longitudinal direction of the track. For instance, in some embodiments, the lateral edge 102 may comprise at least 3 recesses between consecutive ones of the traction projection rows 82, in some embodiments at least 5 recesses between consecutive ones of the traction projection rows 82, in some embodiments at least 8 recesses between consecutive ones of the traction projection rows 82, and in some embodiments even more (e.g., at least 10 recesses between consecutive ones of the traction projection rows 82).

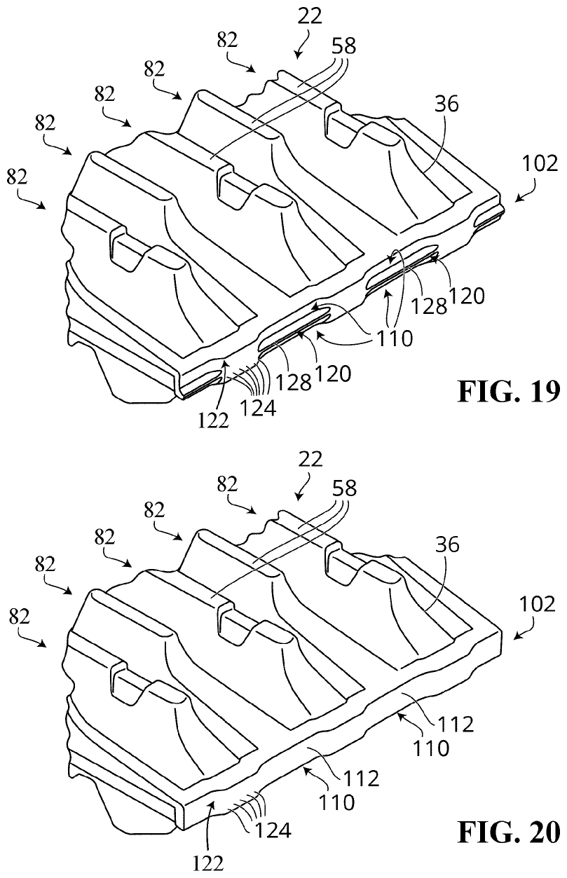

As another example, as shown in FIGS. 19 and 20, in some embodiments, at least one of the lateral edges 102 comprise a surface texture 122, for instance at least partially delimiting at least one of the lateral ground-receiving recesses formed therein. For instance, in this embodiment, the surface texture 122 may define a surface pattern which, in this case, comprises linear texture elements. More specifically, in this embodiment, the surface texture 122 comprises bumps 124, i.e., relatively small protrusions, extending in at least one of the width direction and the thickness direction of the track 22 and distributed in the longitudinal direction of the track 22. The bumps 124 may have a relatively small height. The surface texture 122 may comprise any suitable number of bumps 124. For instance, in some embodiments, the lateral edge 102 may comprise at least about 5 bumps 124 between consecutive ones of the traction projection rows 82, in some embodiments at least 8 bumps 124 between consecutive ones of the traction projection rows 82, in some embodiments at least 10 bumps 124 between consecutive ones of the traction projection rows 82, and in some embodiments even more (e.g., at least 12 bumps 124 between consecutive ones of the traction projection rows 82). In some examples, the bumps 124 may be indicative of a wear of the track 22. In this embodiment, the bumps 124 may be formed during molding of the track 22. In some examples, the bumps 124 may be configured to convey to a user or potential buyer that the tractive formations 110 were formed during molding of the track and/or that the track 22 is new.

### Reinforcing Elements of the Track

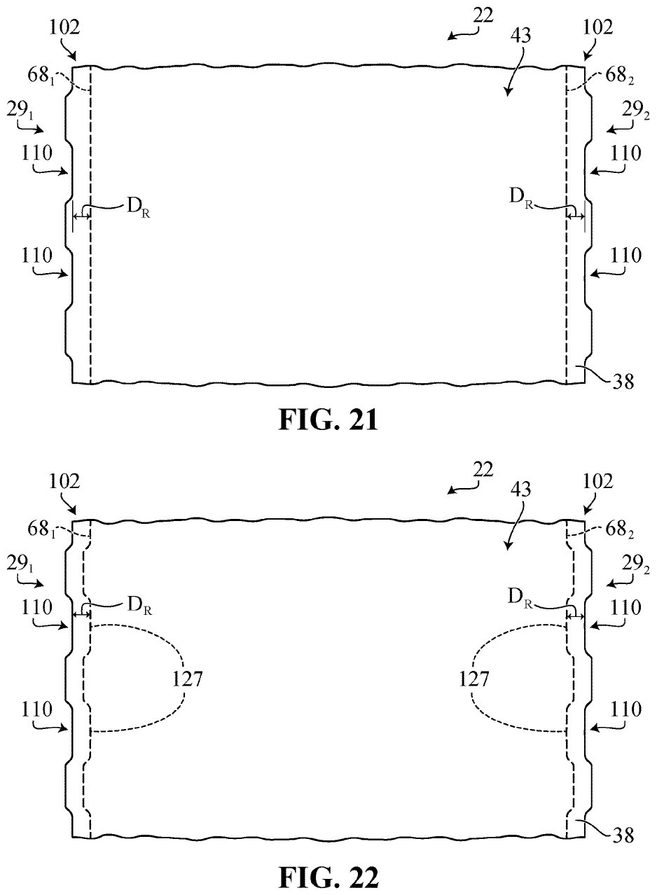

As mentioned above and as represented for instance in FIGS. 21 to 24, the track might comprise a reinforcing layer 43 embedded in elastomeric material of the carcass. In this embodiment and without being limitative, the ground-receiving recesses 112 may be spaced from the layer of reinforcing fabric 43 in order to conceal the layer of reinforcing fabric 43 from the exterior of the carcass 36. For instance, in some embodiments, at each of the lateral sides 29₁, 29₂ of the track 22, the recesses 112 may be spaced from lateral edges 68₁, 68₂ of the layer of reinforcing fabric 43 by a distance D_{R} (see for instance FIGS. 21 and 22). In other words, considered in the widthwise direction of the track, the lateral recesses are spaced apart from the lateral edges of the reinforcing fabric embedded in the elastomeric core of the carcass.

As another example, as shown in FIG. 22, in some embodiments, at least one of the lateral edges 68₁, 68₂ of the layer of reinforcing fabric 43 may be uneven (i.e., non-flat/non-straight) in the longitudinal direction of the track 22, for instance may be curved. For instance, the lateral edges 68₁, 68₂ may define a plurality of layer recesses 127 substantially aligned with (i.e., in register with) the recesses 112 of the lateral edges 102 of the carcass 36 in the longitudinal direction of the track 22.

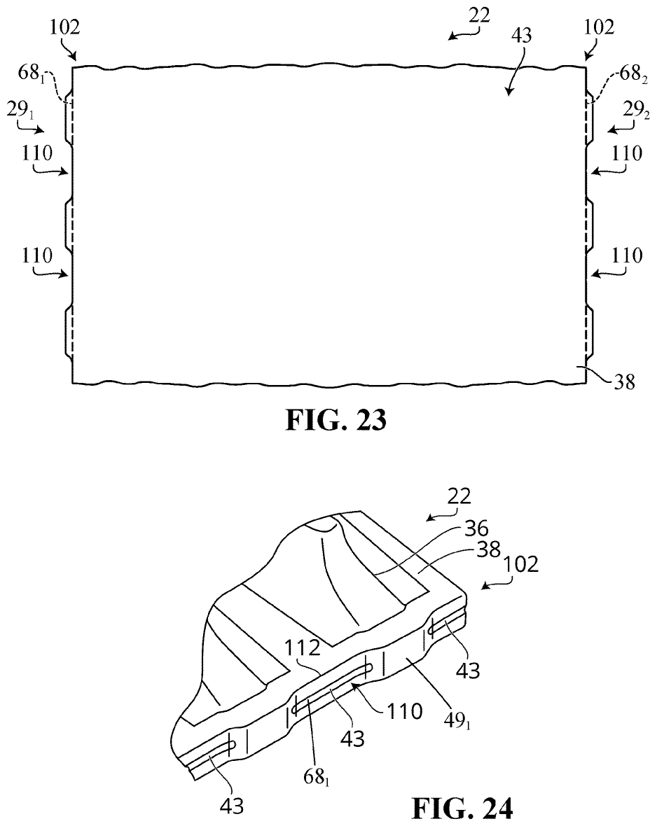

As another example, as shown in FIGS. 23 and 24, in some embodiments, the layer of reinforcing fabric 43 may not be entirely concealed from an exterior of the carcass 36. In particular, in this embodiment, the layer of reinforcing fabric 43 may be exposed to the exterior of the carcass 36 at the recesses 112 and may be concealed from the exterior of the carcass 36 elsewhere. In this example, the recesses 112 may correspond with part of the lateral edges 68₁, 68₂ of the layer of reinforcing fabric 43, and the lateral edges 68₁, 68₂ of the layer of reinforcing fabric 43 may correspond with and not be spaced from respective ones of the lateral edges 49₁, 49₂ of the track 22. In other words, at least a portion of one of the first and second edges of the reinforcing layer might be uncovered at at least one of the ground-receiving recesses formed in the corresponding one of the first and second lateral edges of the track 22. In another embodiment, as represented in FIG. 7, at least a portion of one of the first and second lateral edges of the reinforcing layer extends in at least one of the ground-engaging protrusions of the corresponding one of the first and second lateral edges of the track.

### Technical Advantages

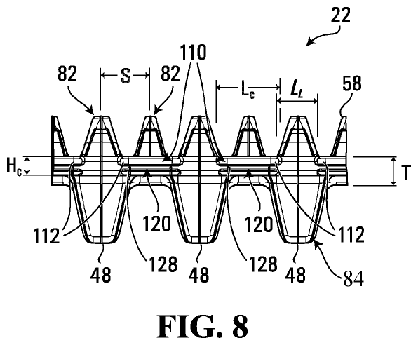

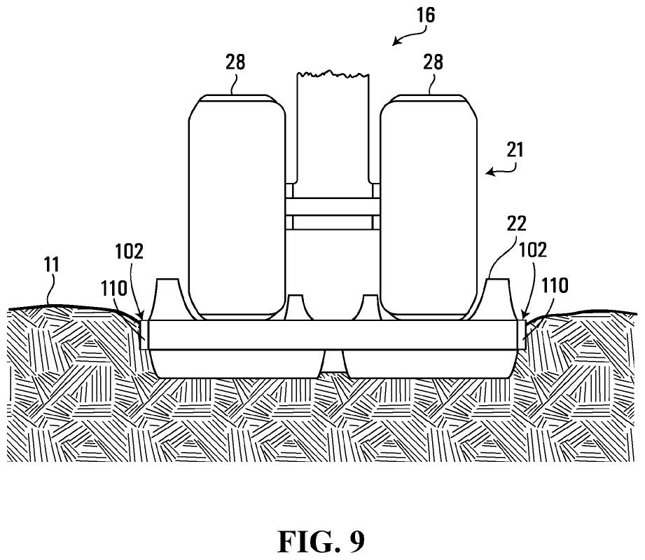

It is thus understood that the track in accordance with the above-described embodiments may be used, as shown in FIG. 9, on a soft terrain or ground 11. When a tracked vehicle is on such a soft terrain, tracks may sink in the soft terrain and the traction provided by prior-art tracks may be reduced because of the soft ground matter. In this embodiment, the track 22 may be shaped and dimensioned such that, when the vehicle 10 is on soft terrain, the lateral edges 102 and the ground-receiving recesses and/or ground-engaging protrusions thereof engage the ground of the soft terrain, thus increasing traction of the vehicle 10. For instance, the ground of the soft terrain may comprise snow, mud, sludge, sand, etc.

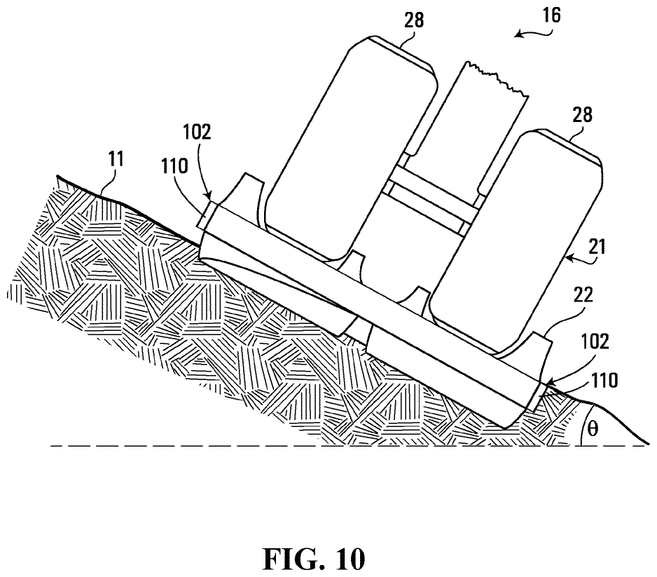

As another example, in another specific application, as shown in FIG. 10, the ground 11 may comprise a sidehill having a slope θ. The track 22 may be shaped and dimensioned such that, when the vehicle 10 is travelling on the sidehill, the sidehill having a downhill direction towards one of the lateral sides 29₁, 29₂ of the track 22 and an uphill direction towards the other one of the lateral sides 29₁, 29₂ of the track 22, one of the lateral edges 102 engages the ground 11. In particular, the lateral edge 102 engaging the ground 11 may correspond to the downhill direction of the sidehill.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A track for traction of a vehicle, the track being mountable around a track-engaging assembly of the vehicle, the track-engaging assembly comprising a plurality of wheels, the track having a longitudinal direction and comprising:
a carcass comprising an outer ground-engaging side, an opposed inner wheel-facing side, and first and second lateral edges extending along the longitudinal direction between the outer and inner sides, the first and second lateral edges being spaced apart from each other in a width direction of the track;
wherein ground-receiving recesses are formed on at least one of the first and second lateral edges.

2. The track according to claim 1, wherein the ground-receiving recesses are spaced-apart from each other in the longitudinal direction of the track.

3. The track according to claim 1, wherein at least one of the ground-receiving recesses extends substantially along an entirety of a thickness of the corresponding one of the first and second lateral edges.

4. The track according to claim 1, further comprising at least one ground-engaging ridge protruding from an inner surface at least partially delimiting one of the ground-receiving recesses, wherein said at least one ground-engaging ridge extends in the longitudinal direction of the track and defines a local apex of the carcass considered in the width direction of the track.

5. (canceled)

6. The track according to claim 1, further comprising traction projections projecting from the outer side of the carcass, wherein, considered in the width direction of the track, at least one of the ground-receiving recesses is spaced from said traction projections.

7. The track according to claim 6, wherein, considered in the longitudinal direction of the track, at least one of the ground-receiving recesses is disposed between longitudinally adjacent ones of the traction projections.

8. The track according to claim 6, wherein the traction projections are arranged in traction projection rows extending in the widthwise direction of the track and disposed along the longitudinal direction thereof, wherein a plurality of said ground-receiving recesses are formed between longitudinally adjacent ones of the traction projection rows.

9. The track according to claim 1, further comprising wheel-engaging projections projecting from the inner side of the carcass, wherein, considered in the width direction of the track, at least one of the ground-receiving recesses is spaced from said wheel-engaging projections, wherein, considered in the longitudinal direction of the track, at least one of the ground-receiving recesses is disposed between longitudinally adjacent ones of the wheel-engaging projections.

10. (canceled)

11. The track according to claim 1, wherein the ground-receiving recesses comprise at least first and second ground-receiving recesses formed respectively in the first and second lateral edges, wherein, considered in the longitudinal direction of the track, the first and second ground-receiving recesses are in register with each other.

12. The track according to claim 1, wherein at least one of the first and second lateral edges comprises a surface texture at least partially delimiting at least one of the ground-receiving recesses formed therein.

13. The track according to claim 1, wherein, considered in a thickness direction of the track, at least one of the ground-receiving recesses has one of a curved profile and an angled profile.

14. The track according to claim 1, further comprising a reinforcing layer embedded in the carcass, the reinforcing layer comprising first and second edges facing respectively the first and second lateral edges of the carcass, wherein a plurality of layer recesses are formed in at least one of the first and second edges of the reinforcing layer, said layer recesses being substantially in register in the longitudinal direction of the track with ground-receiving recesses formed in the corresponding one of the first and second lateral edges of the carcass.

15. The track according to claim 1, further comprising a reinforcing layer embedded in the carcass, the reinforcing layer comprising first and second edges facing respectively the first and second lateral edges of the carcass, wherein at least a portion of one of the first and second edges of the reinforcing layer is uncovered at at least one of the ground-receiving recesses formed in the corresponding one of the first and second lateral edges.

16. A track for traction of a vehicle, the track being mountable around a track-engaging assembly of the vehicle, the track-engaging assembly comprising a plurality of wheels, the track having a longitudinal direction and comprising:
a carcass comprising an outer ground-engaging side and an opposed inner wheel-facing side, first and second lateral edges extending between the outer and inner sides, the first and second lateral edges being spaced apart from each other in a width direction of the track; and
wherein at least one of the first and second lateral edges comprises ground-engaging protrusions.

17. The track according to claim 16, wherein at least one of the ground-engaging protrusions is at least partially made integral with at least one of the outer and inner sides of the carcass.

18. The track according to claim 16, further comprising a reinforcing layer embedded in the carcass, the reinforcing layer comprising first and second edges facing respectively the first and second lateral edges of the carcass, wherein at least a portion of one of the first and second lateral edges of the reinforcing layer extends in at least one of the ground-engaging protrusions of the corresponding one of the first and second lateral edges.

19. The track according to claim 16, wherein at least one of the ground-engaging protrusions is at least partially surrounded by a ground-receiving recess formed in the corresponding one of the first and second lateral edges, said at least one of the ground-engaging protrusions defining a local apex of the carcass considered in the width direction of the track.

20. The track according to claim 16, further comprising traction projections projecting from the outer side of the carcass, wherein, considered in the width direction of the track, at least one of the ground-engaging protrusions is spaced from said traction projections, wherein, considered in the longitudinal direction of the track, at least one of the ground-engaging protrusions is substantially in register with one of the traction projections.

21. (canceled)

22. The track according to claim 16, further comprising wheel-engaging projections projecting from the inner side of the carcass, wherein, considered in the width direction of the track, at least one of the ground-engaging protrusions is spaced from said wheel-engaging projections, wherein, considered in the longitudinal direction of the track, at least one of the ground-engaging protrusions is substantially in register with one of the wheel-engaging projections.

23. (canceled)

24. The track according to claim 16, comprising at least first and second ground-engaging protrusions protruding respectively from the first and second lateral edges, wherein, considered in the longitudinal direction of the track, the first and second ground-engaging protrusions are in register with each other.

25. (canceled)
